(19) United States
(12) Patent Application Publication
(10) Pub. No.: US 2020/0079448 A1
(43) Pub. Date: Mar. 12, 2020

(54) FOUR-WHEEL CHASSIS, TWO-WHEEL CHASSIS, ASSEMBLY AND CONTROL METHOD THEREOF

(71) Applicant: SZ DJI TECHNOLOGY CO., LTD., Shenzhen (CN)

(72) Inventors: Yiqi CHEN, Shenzhen (CN); Fang LIU, Shenzhen (CN); Zhenxu WANG, Shenzhen (CN)

(21) Appl. No.: 16/683,459

(22) Filed: Nov. 14, 2019

Related U.S. Application Data
(63) Continuation of application No. PCT/CN2017/091282, filed on Jun. 30, 2017.

(51) Int. Cl. B62D 61/12; B62D 63/04; B60K 1/00; B60K 17/356; F41A 23/34

(52) U.S. Cl. CPC B62D 61/12; B62D 63/04; F41A 23/34; B60K 17/356; B60K 1/00

(57) ABSTRACT

A four-wheel chassis comprising a body, and a front wheel assembly and a rear wheel assembly detachably coupled to the body. After detached from the body, one of the front wheel assembly and the rear wheel assembly independently moves as a two-wheel chassis. The one of the front wheel assembly and the rear wheel assembly is connected to a wheel driving controller that controls wheels of the two-wheel chassis.

### CROSS-REFERENCE TO RELATED APPLICATION

This application is a continuation application of International Application No. PCT/CN2017/091282, filed on Jun. 30, 2017, the entire contents of which are incorporated herein by reference.

### TECHNICAL FIELD

The present disclosure relates to the field of chassis technology and, more particularly, to a four-wheel chassis, a two-wheel chassis, an assembly and a control method thereof.

### BACKGROUND

With the continuous development of mechanical and electronic technology, the applications of chassis have become more and more extensive. Common chassis is often a four-wheel chassis which includes a body, a front wheel assembly, and a rear wheel assembly. The body can be freely equipped with a variety of main device to diversify the use and play of the chassis. For example, a gimbal and a photographing device may be mounted at the body, allowing the chassis to be used for landscape photography.

When a user plays with a four-wheel chassis, gaming experience based on a four-wheel chassis may be realized, such as racing, taking video or photos, accepting specific instructions to complete certain transportation actions, etc. However, when the user wants to have game experience of two-car competition, the user may have to purchase two four-wheel chassis to meet the demand, resulting in high cost and inconvenience.

### SUMMARY

In accordance with the disclosure, there is provided a four-wheel chassis. The four-wheel chassis comprises a body, and a front wheel assembly and a rear wheel assembly detachably coupled to the body. After detached from the body, one of the front wheel assembly and the rear wheel assembly independently moves as a two-wheel chassis. The one of the front wheel assembly and the rear wheel assembly is connected to a wheel driving controller that controls wheels of the two-wheel chassis.

Also, in accordance with the disclosure, there is provided a two-wheel chassis. The two-wheel chassis comprises wheels; and a connecting plate coupled to the wheels. The connecting plate is detachably coupled to a body. After coupled to the body, two two-wheel chassis form a four-wheel chassis in which the two two-wheel chassis move integrally.

Also, in accordance with the disclosure, there is provided a four-wheel chassis assembly. The four-wheel chassis assembly comprises a main device and a four-wheel chassis. The four-wheel chassis comprises a body, and a front wheel assembly and a rear wheel assembly detachably coupled to the body. After detached from the body, one of the front wheel assembly and the rear wheel assembly independently moves as a two-wheel chassis. The one of the front wheel assembly and the rear wheel assembly is connected to a wheel driving controller that controls wheels of the two-wheel chassis.

### BRIEF DESCRIPTION OF THE DRAWINGS

FIG. 1 is schematic diagram of a four-wheel chassis according to an embodiment of the disclosure.

FIG. 2 is a perspective view of the four-wheel chassis in FIG. 1 from another aspect.

FIG. 3 is a perspective view of the four-wheel chassis in FIG. 2 from another aspect.

FIG. 4 is a perspective view of the four-wheel chassis in FIG. 3 from another aspect.

FIG. 5 is a schematic diagram of the four-wheel chassis in FIG. 1 carrying a main device.

FIG. 6 is a schematic diagram of the four-wheel chassis in FIG. 1 after a disassembly.

FIG. 7 is a schematic diagram showing a connection of a four-wheel driving controller, electronic governors, and motors in a four-wheel chassis according to an embodiment of the disclosure.

FIG. 8 is a flowchart of a four-wheel chassis controlling method according to an embodiment of the disclosure.

### DESCRIPTION OF MAIN COMPONENTS AND REFERENCE NUMERALS

| | |
|---|---|
| Body | 1 |
| Front wheel assembly | 2 |
| Rear wheel assembly | 3 |
| Main device | 4 |
| Four-wheel driving controller | 101 |
| Electronic governor | 102 |
| Front wheel | 201 |
| Front connecting plate | 202 |
| Front motor | 203 |
| Rear wheel | 301 |
| Rear connecting plate | 302 |
| Rear motor | 303 |

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It is also to be understood that the terminology used herein is for the purpose of describing particular embodiments only, and is not intended to be limiting. As used in this specification and the appended claims, terms in the singular and the singular forms “a”, “an” and “the”, for example, include plural referents unless the content clearly dictates otherwise. As used herein, where the indefinite article “a” or “an” is used with respect to a statement or description of the presence of a step in a process disclosed herein, unless the statement or description explicitly provides to the contrary, the use of such indefinite article is not intended to limit the presence of the step in the process to one in number.

As used herein, when a first component is referred to as “mounted” at a second component, it is intended that the first component may be directly mounted at the second component or may be indirectly mounted at the second component via a third component between them. When a first component is referred to as “connecting/connected” to a second component, it is intended that the first component may be directly connecting/coupled to the second component or may be indirectly connecting/coupled to the second component via a third component between them. When a first component is referred to as “arranged” at a second component, it is intended that the first component may be directly arranged at the second component or may be indirectly arranged at the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Depending on the context, the word “if” as used herein may be construed as “at the time when . . . ” or “when . . . ” or “responsive to determining” or “responsive to detecting”. Similarly, depending on the context, phrases “if . . . is determined” or “if . . . (stated condition or event) is detected” may be construed as “when . . . is determined” or “responsive to determining” or “when . . . (stated condition or event) is detected” or “responsive to detecting (stated condition or event)”.

Moreover, the terms, “comprise”, “include” or any other variants, in the present application are intended to cover non-exclusive inclusion, so that the process, method, article or apparatus including a series of elements may not only include those elements, but may also include other elements not stated explicitly, or elements inherent to the process, method, articles or apparatus. Without more limitations, an element defined by the sentence “comprising a . . . ” does not exclude the condition that there are other same elements in the process, method, article or apparatus including the element.

Exemplary embodiments will be described with reference to the accompanying drawings. In the situation where the technical solutions described in the embodiments are not conflicting, they can be combined.

The present disclosure provides a four-wheel chassis vehicle, a two-wheel chassis vehicle, an assembly, and a control method thereof to solve the issue of high cost of using the chassis in the conventional technologies.

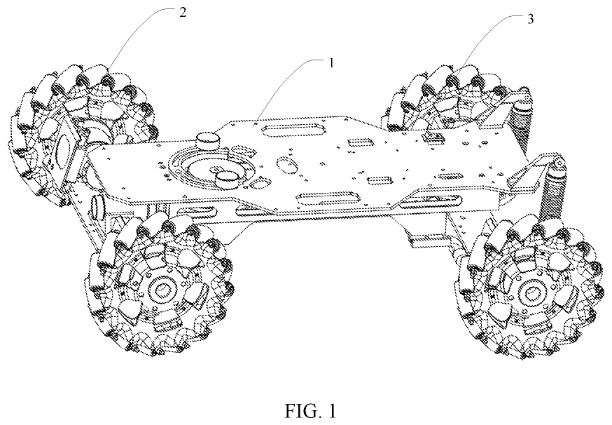

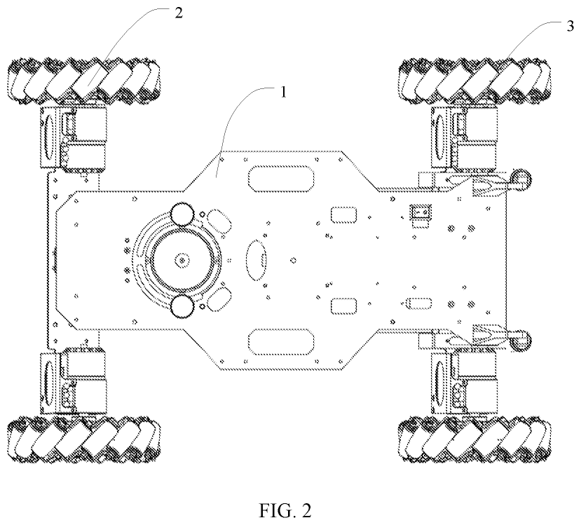

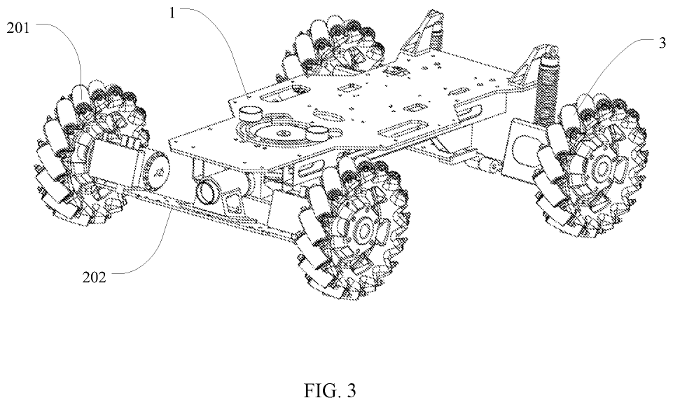

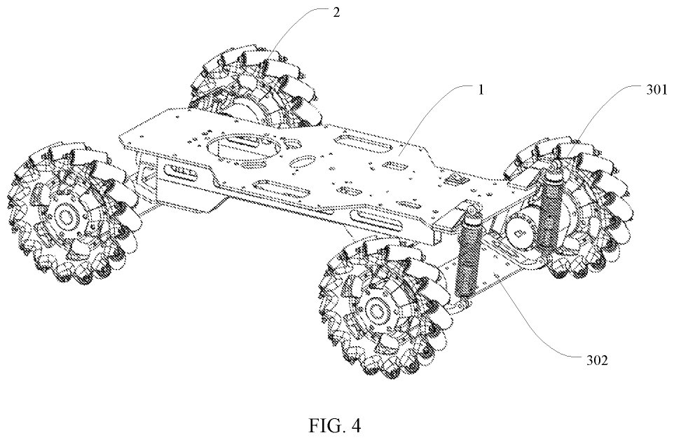

The present disclosure provide a four-wheel chassis. FIG. 1 is schematic diagram of a four-wheel chassis according to an embodiment of the disclosure. FIG. 2 is a perspective view of the four-wheel chassis in FIG. 1 from another aspect. FIG. 3 is a perspective view of the four-wheel chassis in FIG. 2 from another aspect. FIG. 4 is a perspective view of the four-wheel chassis in FIG. 3 from another aspect.

As shown in FIG. 1 to FIG. 4, the four-wheel chassis may include a body 1, a front wheel assembly 2, and a rear wheel assembly 3. The front wheel assembly 2 and the rear wheel assembly 3 may be detachably coupled to the body 1. The front wheel assembly 2 or the rear wheel assembly 3 may be detached from the body 1. After detached from the body 1, the front wheel assembly 2 or the rear wheel assembly 3 may independently move as a two-wheel chassis. The body 1 may be configured to carry a main device 4.

The specific shape and structure of the body 1 may be determined according to various application scenarios, which is not limited by the present disclosure. For example, the body 1 may include a plastic plate or a metal plate for carrying the main device 4, and an interface for mounting other devices at the plastic plate or the metal plate, such as an interface for mounting the main device 4, an interface for mounting a controller. In addition, a connector for coupling the front wheel assembly 2 or the rear wheel assembly 3 to the body 1 may be provided at both ends of the plastic plate or the metal plate.

The body 1 may be configured to carry one or more main devices 4, including but not limited to a gimbal, a photographing device, a magazine, a firing device, and a detecting device, etc.

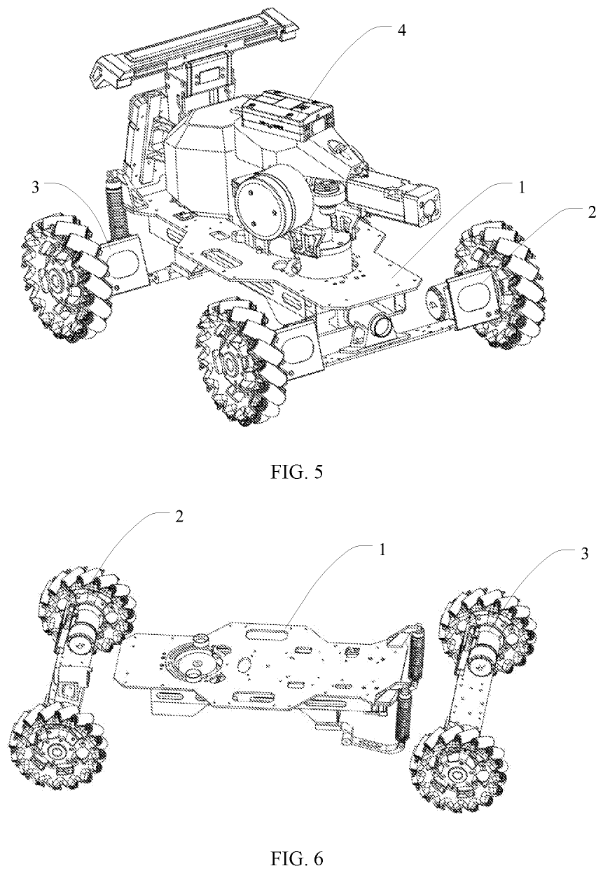

FIG. 5 is a schematic diagram of the four-wheel chassis in FIG. 1 carrying the main device 4. As shown in FIG. 5, the main device 4 may be mounted at the four-wheel chassis. After the four-wheel chassis is equipped with the main device 4, a corresponding function may be realized.

For example, a magazine and a firing device may be carried by the body 1, such that the four-wheel chassis may be used for a racing game. A gimbal and a photographing device may be carried by the body 1, such that the four-wheel chassis may be used for landscape photography. An investigating device or a detecting device may be carried by the body 1, such that the four-wheel chassis may be used for terrain exploration, military investigation, and the like.

The coupling between the body 1 and the main device 4 may be achieved by screwing or snapping. Correspondingly, the body 1 may be provided with a snap portion or a threaded through-hole or the like for mounting the main device 4.

In addition to the body 1, the four-wheel chassis may further include the front wheel assembly 2 and the rear wheel assembly 3. The front wheel assembly 2 and the rear wheel assembly 3 may be respectively disposed at two ends of the body 1 and coupled to the body 1 to drive the body 1 to move.

The front wheel assembly 2 may include two wheels and the rear wheel assembly 3 may include two wheels, such that together with the body 1, the front wheel assembly 2 and the rear wheel assembly 3 may form a four-wheel chassis.

The front wheel assembly 2 and the body 1 may be detachably coupled, and the rear wheel assembly 3 and the body 1 may also be detachably coupled. The front wheel assembly 2 or the rear wheel assembly 3 may independently move as a two-wheel chassis after being detached from the body 1.

FIG. 6 is a schematic diagram of the four-wheel chassis in FIG. 1 after a disassembly. As shown in FIG. 6, the four-wheel chassis may be disassembled into three independent components: the body 1, the front wheel assembly 2, and the rear wheel assembly 3.

The front wheel assembly 2 and the body 1 may be detachably coupled in various ways, such as screwing, snapping, coupled by a quick release structure, and the like. Similarly, the detachable coupling between the rear wheel assembly 3 and the body 1 may also be achieved by any one or more of the above-mentioned ways.

In one embodiment, the front wheel assembly 2/the rear wheel assembly 3 may comprise a connecting plate and wheels. In particular, as shown in FIGS. 3-4, the front wheel assembly 2 may include front wheels 201 and a front connecting plate 202, and the rear wheel assembly 3 may include rear wheels 301 and a rear connecting plate 302.

In the front wheel assembly 2/the rear wheel assembly 3, the wheels and the connecting plate may be coupled by screws, and the connecting plate and the body 1 may be coupled by a suspension structure. In particular, the suspension structure may include an independent suspension or a non-independent suspension. In one embodiment, the wheel may be a Mecanum wheel. The Mecanum wheel has a compact structure, enabling a more flexible and convenient omnidirectional movement. In another embodiment, the wheel may be an ordinary wheel capable of being adjusted according to the configuration of the four-wheel chassis.

Furthermore, the front wheel assembly 2 may be provided with the main device 4, or the front wheel assembly 2 may further include a connector for connecting the main device 4.

The connection between the front wheel assembly 2 and the main device 4 may be achieved in various ways. The connector of the front wheel assembly 2 for connecting the main device 4 may include a snap, a screw, a bonding part, a welded part or other interface.

Similarly, the rear wheel assembly 3 may also be provided with the main device 4, or the rear wheel assembly 3 may further include a connector for connecting the main device 4.

The connection between the rear wheel assembly 3 and the main device 4 may be achieved in various ways. The connector of the rear wheel assembly 3 for connecting the main device 4 may include a snap, a screw, a bonding part, a welded part or other interface.

In one embodiment, the main device 4 connected to the front wheel assembly 2, the main device 4 connected to the rear wheel assembly 3, and the main device 4 connected to the body 1 may be the same device. For example, each of the front wheel assembly 2, the rear wheel assembly 3 and the body 1 may be disposed with a connector for connecting a camera.

In another embodiment, the main device 4 connected to the front wheel assembly 2, the main device 4 connected to the rear wheel assembly 3, and the main device 4 connected to the body 1 may be different devices. For example, each of the front wheel assembly 2 and the rear wheel assembly 3 may be disposed with a connector for connecting a magazine, while the body 1 may be disposed with a connector for connecting a camera.

It can be understood that the specific shape of the front wheel assembly 2 and the rear wheel assembly 3 may be determined according to various application scenarios, and the shape and structure of the front wheel assembly 2 and the rear wheel assembly 3 may be the same or different, as long as the front wheel assembly 2 and the rear wheel assembly 3 each is able to independently move as a two-wheel chassis after removed from the body 1.

In practical applications, the four-wheel chassis may include three detachable parts: the body 1, the front wheel assembly 2 and the rear wheel assembly 3. After being assembled together, the three parts may together be configured as a four-wheel chassis. After being disassembled into three independent parts, the front wheel assembly 2 and the rear wheel assembly 3 may be respectively configured as a two-wheel chassis, and one or more main devices 4 may be mounted at the front wheel assembly 2 or the rear wheel assembly 3, thereby realizing the functions of the two-wheel chassis, such as playing a competition game without purchasing extra two-wheel chassis. After the two two-wheel chassis are recoupled with the body 1, the four-wheel chassis may be reformed.

In the disclosed embodiments, the four-wheel chassis may include the body 1, the front wheel assembly 2 and the rear wheel assembly 3. The front wheel assembly 2 and the rear wheel assembly 3 may be detachably coupled to the body 1. After being detached from the body 1, the front wheel assembly 2 or the rear wheel assembly 3 may independently move as a two-wheel chassis. Thus, the user demands of both the four-wheel chassis and two-wheel chassis may be satisfied without purchasing extra two-wheel chassis, which may effectively reduce the cost of using the chassis and provide convenience to the user.

In some embodiments, the four-wheel chassis may be further provided with a controller for controlling the wheels, which will be explained in the following.

The present disclosure provides a four-wheel chassis where a four-wheel driving controller may be disposed at the body. The four-wheel driving controller may be configured to control the wheels of the front wheel assembly 2 and the rear wheel assembly 3.

To drive the wheels to move, motors corresponding to the wheels may be disposed at the four-wheel chassis. In particular, the front wheel assembly 2 and the rear wheel assembly 3 each may include two motors, which may respectively drive four wheels included in the front wheel assembly 2 and the rear wheel assembly 3 to move. The four-wheel driving controller may be configured to control the motors disposed at the front wheel assembly 2 and the rear wheel assembly 3 to drive the wheels to move.

In one embodiment, the four-wheel chassis may further include four electronic governors 102 disposed at the body 1. The four-wheel driving controller may control the four motors to drive the four wheels of the front wheel assembly 2 and the rear wheel assembly 3 to move by the four electronic governors.

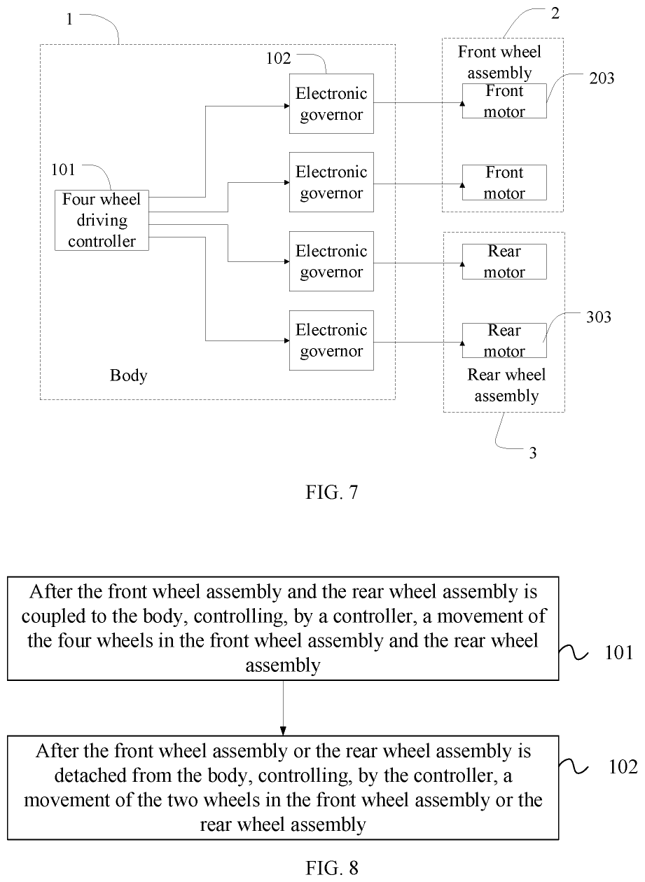

FIG. 7 is a schematic diagram showing a connection of a four-wheel driving controller, electronic governors, and motors in a four-wheel chassis according to an embodiment of the disclosure. For convenience of description, the motor in the front wheel assembly 2 may be referred to as a front motor 203, and the motor in the rear wheel assembly 3 may be referred to as a rear motor 303. As shown in FIG. 7, the body 1 may be provided with a four-wheel driving controller 101 and four electronic governors 102, and the input terminals of the four electronic governors 102 may be coupled to the four-wheel driving controller 101. The output terminals of the four electronic governors 102 may be respectively coupled to the two front motors 203 of the front wheel assembly 2 and the two rear motors 303 of the rear wheel assembly 3.

The four-wheel driving controller 101 may control the front motors 203 and the rear motors 303 by the four electronic governors 102, thereby enabling the front motors 203 to drive two wheel in the front wheel assembly 2 to move and the rear motors 303 to drive the two wheels of the rear wheel assembly 3 to move.

The method for controlling the motors to drive the wheels to move by the electronic governor 102 is existing technology, which will not be described in detail herein.

It can be understood that the body 1 and the front wheel assembly 2/rear wheel assembly 3 may be provided with corresponding electrical interfaces. After the body 1 is coupled to the front wheel assembly 2/rear wheel assembly 3 to form the four-wheel chassis, the electronic governor 102 at the body 1 may be electrically connected to the motors at the front wheel assembly 2/rear wheel assembly 3 through the corresponding electrical interface.

In some embodiments, the electronic governor 102 may be disposed at the front wheel assembly 2 and the rear wheel assembly 3. In particular, the front wheel assembly 2 may be provided with two electronic governors 102 and two motors, and the rear wheel assembly 3 may be provided with two electronic governors 102 and two motors. The body 1 and the front wheel assembly 2/rear wheel assembly 3 may be provided with corresponding electrical interfaces. After the body 1 and the front wheel assembly 2/rear wheel assembly 3 are coupled together to form a four-wheel chassis, the four-wheel driving controller 101 at the body 1 may be electrically connected to the electronic governors 102 at the front wheel assembly 2/rear wheel assembly 3 through the corresponding electrical interface.

In some embodiments, two wheels may share one motor. In some embodiments, two motors may share one electronic governor 102. In some embodiments, only the front wheel assembly 2 may be provided with a motor, while the wheels of the rear wheel assembly 3 may be driven wheels. In some embodiments, only the rear wheel assembly 3 may be provided with a motor, while the wheels of the front wheel assembly 2 may be driven wheels. Thus, the number of the electronic governors 102 or the motors may be effectively reduced, reducing the cost of the four-wheel chassis.

In the disclosed embodiments, the four-wheel driving controller 101, the electronic governor 102 and the motors may be disposed at the body 1, the front wheel assembly 2 and the rear wheel assembly 3. Thus, the wheels of the four-wheel chassis may be driven and controlled, realizing the movement and stop of the four-wheel chassis.

The present disclosure provides a four-wheel chassis where the four-wheel driving controller and the body may be detachably coupled.

Further, one of the front wheel assembly 2 and the rear wheel assembly 3 may include a controller interface for connecting with the four-wheel driving controller 101. After one of the front wheel assembly 2 and the rear wheel assembly 3 is disassembled from the body 1, and the four-wheel driving controller 101 is connected to the controller interface of one of the front wheel assembly 2 and the rear wheel assembly 3, the four-wheel driving controller 101 may be further configured to control the movement of the two wheels of one of the front wheel assembly 2 and the rear wheel assembly 3.

In one embodiment, the front wheel assembly 2 and/or the rear wheel assembly 3 may be provided with an electronic governor and a motor. After the four-wheel driving controller 101 is connected to the controller interface of one of the front wheel assembly 2 and the rear wheel assembly 3, an electrical connection with the electronic governor 102 may be realized, thereby controlling the motor to drive the wheels through the electronic governor 102.

In practical applications, after the user assemblies the body 1, the front wheel assembly 2 and the rear wheel assembly 3 as a four-wheel chassis, the four-wheel driving controller 101 may be mounted at the body 1 to control the wheels of the front wheel assembly 2 and the rear wheel assembly 3. When the user wants to use the two-wheel chassis, one of the front wheel assembly 2 and the rear wheel assembly 3 may be disassembled from the body 1, and the four-wheel driving controller 101 may be detached from the body 1 and mounted at one of the front wheel assembly 2 and the rear wheel assembly 3. When one of the front wheel assembly 2 and the rear wheel assembly 3 is configured as a two-wheel chassis, the four-wheel driving controller 101 may control the wheels of one of the front wheel assembly 2 and the rear wheel assembly 3, thereby realizing the moving of the two-wheel chassis.

In the disclosed embodiments, the four-wheel driving controller 101 may be detachably coupled to the body 1, and one of the front wheel assembly 2 and the rear wheel assembly 3 may include a controller interface for connecting the four-wheel driving controller 101. After one of the front wheel assembly 2 and the rear wheel assembly 3 is detached from the body 1, and the four-wheel driving controller 101 is connected to the controller interface of one of the front wheel assembly 2 and the rear wheel assembly 3, the four-wheel driving controller 101 may also control the movement of the two wheels of one of the front wheel assembly 2 and the rear wheel assembly 3 without purchasing extra controller for driving the two-wheel chassis, thereby saving cost and providing convenience to the user.

The present disclosure provides a four-wheel chassis where a two-wheel driving controller may be further disposed at one of the front wheel assembly 2 and the rear wheel assembly 3. The two-wheel driving controller may be configured to control the wheels of one of the front wheel assembly 2 and the rear wheel assembly 3 after one of the front wheel assembly 2 and the rear wheel assembly 3 is detached from the body 1.

In one embodiment, the two-wheel driving controller may be configured to acquire the center of gravity of one of the front wheel assembly 2 and the rear wheel assembly 3, and control the wheels (i.e., the movement of the wheels) in one of the front wheel assembly 2 and the rear wheel assembly 3 according to the center of gravity.

One of the front wheel assembly 2 and the rear wheel assembly 3 may further be equipped with a main device. In one embodiment, the main device may be a magazine and a bullet launcher. Correspondingly, one of the front wheel assembly 2 and the rear wheel assembly 2 may further include a connector configured to connect the magazine and the bullet launcher.

When the front wheel assembly 2/the rear wheel assembly 3 is equipped with the magazine and the bullet launcher, the two-wheel drive controller may be further configured to: after the front wheel assembly 2/the rear wheel assembly 3, or the magazine, or the bullet launcher is hit, control one of the front wheel assembly 2 and the rear wheel assembly 3 to fall down, or control an indicator to turn off, or generate smoke, thereby simulating the effects of damage.

In practical application, the four-wheel chassis may be disassembled into two two-wheel chassis equipped with a magazine and a bullet launcher. The two two-wheel chassis may be controlled by the two-wheel driving controller according to the center of gravity to move without falling to the ground. In the process of shooting confrontation between the two two-wheel chassis, the two-wheel chassis that was hit may simulate the effect of being knocked down after being shot or simulate the effect of being damaged after being hit such as turning off the indicator light or smoking, etc., thereby realizing the DIY experience of multi-scene and multi-function of four-wheel chassis.

In the disclosed embodiments, a two-wheel driving controller may be disposed at one of the front wheel assembly 2 and the rear wheel assembly 3, and the smooth movement of one of the front wheel assembly 2 and the rear wheel assembly 3 may be realized by controlling the center of gravity, such that the user may conveniently configure one of the front wheel assembly 2 and the rear wheel assembly 3 as a two-wheel chassis.

The present disclosure provides a four-wheel chassis where a controller interface may be further disposed at one of the front wheel assembly 2 and the rear wheel assembly 3. The controller interface may be configured to connect a two-wheel driving controller that controls the movement of the wheel after one of the front wheel assembly 2 and the rear wheel assembly 3 is removed from the body 1.

In the disclosed embodiments, the four-wheel chassis may be provided with a controller interface at one of the front wheel assembly 2 and the rear wheel assembly 3, and the controller interface may be configured to connect a two-wheel driving controller that controls the wheels after one of the front wheel assembly 2 and the rear wheel assembly 3 is removed from the body 1. The user may install a corresponding controller at one of the front wheel assembly 2 and the rear wheel assembly 3 according to actual needs, such that the functions of the two-wheel chassis may be flexible and diversified, and different application scenarios may be satisfied.

In the disclosed embodiments, an electronic governor 102 may be disposed at one of the front wheel assembly 2 and the rear wheel assembly 3, and the two-wheel driving controller may be coupled to the electronic governor 102. The electronic governor 102 may control the motor to drive the wheel to move. In another embodiment, in one of the front wheel assembly 2 and the rear wheel assembly 3, a governor interface for connecting the electronic governor 102 may be disposed at one of the front wheel assembly 2 and the rear wheel assembly 3. After the user manually installs the electronic governor 102 at one of the front wheel assembly 2 and the rear wheel assembly 3, the two-wheel driving controller may be electrically connected to the electronic governor 102, and the electronic governor 102 controls the motor to drive the wheels.

The present disclosure provides a two-wheel chassis which includes wheels and a connecting plate coupled to the wheels. The connecting plate may be detachably coupled to the body 1. After coupled to the body 1, two two-wheel chassis may form a four-wheel chassis in which the two two-wheel chassis move integrally.

The two-wheel chassis may be any one of the front wheel assembly 2 and the rear wheel assembly 3 of the disclosed four-wheel chassis. The structural diagram of the two-wheel chassis may be referred to one of the front wheel assembly 2 and the rear wheel assembly 3 in FIG. 6. The structure, function, and connection relationship of the components in the two-wheel chassis may be referred to any of the above embodiments, and details are not described herein again.

In one embodiment, the two-wheel chassis may further include a controller configured to control the wheels, i.e., a wheel controller. In particular, the controller may be configured to acquire the center of gravity of the two-wheel chassis and control the wheels according to the center of gravity.

In another embodiment, the two-wheel chassis may further include a controller interface for connecting a controller which is configured to control the wheels, i.e., a controller interface for connecting a wheel controller.

The wheels controller may be the two-wheel driving controller in the four-wheel chassis according to any of the above embodiments.

Further, the two-wheel chassis may further include a connector for connecting the main device 4. The main device 4 may include, but may be not limited to, a gimbal, a photographing device, a magazine, a firing device, and a detecting device.

In practical applications, the user may configure the two-wheel chassis to carry the main device 4, such as a magazine and a bullet launching mechanism for a competition. When the user desires to use a four-wheel chassis, two of the disclosed two-wheel chassis may be assembled with the body 1 to form a four-wheel chassis without purchasing an entire four-wheel chassis. When the user desires to use a two-wheel chassis, the two-wheel chassis may be detached from the body 1.

In the disclosed embodiments, the two-wheel chassis may include wheels and a connecting plate coupled to the wheels. The connecting plate may be detachably coupled to the body 1. After coupled to the body 1, two two-wheel chassis may form a four-wheel chassis in which the two two-wheel chassis move integrally. Thus, the user demands of both the four-wheel chassis and the two-wheel chassis may be satisfied without purchasing an entire four-wheel chassis, which effectively reduces the cost of using the chassis and provides convenience to the user.

The present disclosure provides a four-wheel chassis assembly, which comprises a main device 4 and a four-wheel chassis according to any one of the above embodiments. The main device 4 may include, but may be not limited to, a gimbal, a photographing device, a magazine, a firing device, and a detecting device.

The schematic structural view of the four-wheel chassis assembly may be made to FIG. 5. The structure, the function, and the connection relationship of the components in the four-wheel chassis assembly may be referred to the foregoing embodiments, and details may be not described herein again.

The four-wheel chassis assembly may include a body 1, a front wheel assembly 2, and a rear wheel assembly 3. The front wheel assembly 2 and the rear wheel assembly 3 may be detachably coupled to the body 1. After being detached from the body 1, one of the front wheel assembly 2 and the rear wheel assembly 3 may independently move as a two-wheel chassis. Thus, the user demands of both the four-wheel chassis and two-wheel chassis may be satisfied without purchasing extra two-wheel chassis, which may effectively reduce the cost of using the chassis and provide convenience to the user.

Further, the four-wheel chassis assembly may further include a remote controller, which may communicate with a controller on the four-wheel chassis by wireless or the like. The user may input a control command to the remote controller, and the remote controller may send a signal to the controller on the four-wheel chassis according to the control command, such that the controller may control the four-wheel chassis to perform corresponding actions, such as move forward, move backward, or turn by a certain angle.

In some embodiments, the user may communicate with the controller on the four-wheel chassis through a user equipment, such as a smart phone, a computer, a tablet device, or the like. By installing software for controlling the four-wheel chassis in the user equipment, communication with the controller on the four-wheel chassis may be realized, thereby controlling the four-wheel chassis.

The present disclosure provides a method for controlling a four-wheel chassis. FIG. 8 is a flowchart of a four-wheel chassis controlling method according to an embodiment of the disclosure. The four-wheel chassis may be any one of the disclosed four-wheel chassis.

As shown in FIG. 8, the method may include:

Step 101: after the front wheel assembly 2 and the rear wheel assembly 3 is coupled to the body 1, controlling, by a controller, a movement of the four wheels of the front wheel assembly 2 and the rear wheel assembly 3;

Step 102: after one of the front wheel assembly 2 and the rear wheel assembly 3 is detached from the body 1, controlling, by the controller, a movement of the two wheels of one of the front wheel assembly 2 and the rear wheel assembly 3.

The method may be applied to any one of the disclosed four-wheel chassis. The structure of the four-wheel chassis may be referred to the foregoing embodiments, and details are not described herein again.

The controller may be disposed at the body 1. After the front wheel assembly 2 and the rear wheel assembly 3 are coupled to the body 1, the controller may control the movement of four wheels of the front wheel assembly 2 and the rear wheel assembly 3. After one of the front wheel assembly 2 and the rear wheel assembly 3 is detached from the body 1, the controller may be detached from the body 1 and installed into the detached one of the front wheel assembly 1 and the rear wheel assembly 1, and the detached one of the front wheel assembly 2 and the rear wheel assembly 3 may be configured as an independent two-wheel chassis. The controller may control the movement of the two wheels of the detached one of the front wheel assembly 2 and the rear wheel assembly 3.

In some embodiments, the controller may include a four-wheel driving controller 101 disposed at the body 1 and a two-wheel driving controller disposed at one of the front wheel assembly 2 and the rear wheel assembly 3. Correspondingly, after the front wheel assembly 2 and the rear wheel assembly 3 are coupled to the body 1, when the controller controls the movement of the four wheels of the front wheel assembly 2 and the rear wheel assembly 3, the four-wheel driving controller may control the movement of the four wheels of the front wheel assembly 2 and the rear wheel assembly 3. After one of the front wheel assembly 2 and the rear wheel assembly 3 is detached from the body 1, when the controller controls the movement of the two wheels of one of the front wheel assembly 2 and the rear wheel assembly 3, the two-wheel driving controller may control the movement of the two wheels of the detached one of the front wheel assembly 2 and the rear wheel assembly 3.

Further, when the controller controls the movement of the two wheels of one of the front wheel assembly 2 and the rear wheel assembly 3, the controller may acquire a center of gravity of one of the front wheel assembly 2 and the rear wheel assembly 3, and control the movement of the two wheels of one of the front wheel assembly 2 and the rear wheel assembly 3 according to the center of gravity.

The specific principle and implementation manner of controlling the movement of the wheels by the controller may be similar to the above embodiments, and details are not described herein again.

It can be understood that, in the disclosed method, the order of step 101 and step 102 may be interchangeable. That is, one of the front wheel assembly 2 and the rear wheel assembly 3 may be firstly controlled as an independent two-wheel chassis. Then the front wheel assembly 2, the rear wheel assembly 3 and the body 1 may be assembled to form a four-wheel chassis for controlling.

In the disclosed embodiments, after the front wheel assembly 2 and the rear wheel assembly 3 is coupled to the body 1, the controller may control the movement of the four wheels of the front wheel assembly 2 and the rear wheel assembly 3. After one of the front wheel assembly 2 and the rear wheel assembly 3 is detached from the body 1, the controller may control the movement of the two wheels of one of the front wheel assembly 2 and the rear wheel assembly 3. Thus, the driving of the four-wheel chassis and the two-wheel chassis may be realized, which may effectively reduce the cost and provide convenience to users.

It will be understood by those skilled in the art that B is mounted at A mentioned in the embodiments of the present disclosure merely indicates that B and A are fixedly connected or detachably connected, and does not necessarily mean that B is located above A.

In the several embodiments provided in the present disclosure, it should be understood that the disclosed system, apparatus, and method may be implemented in other manners. For example, the described apparatus embodiment may be merely exemplary. For example, the unit division may be merely a logical function division and there may be other divisions in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions in the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit may be implemented in a form of a software functional unit and sold or used as an independent product, the integrated unit may be stored in a computer-readable storage medium. Based on such an understanding, all or a part of the technical solutions may be implemented in a form of a software product. The computer software product may be stored in a storage medium and may include several instructions for instructing a computer device (which may be a personal computer, a server, or a network device) to perform all or a part of the steps of the methods described in the embodiments of the present disclosure. The foregoing storage medium may include any medium that may store code, such as a universal serial bus (USB) flash drive, a removable hard disk, a read-only memory (ROM), a random-access memory (RAM), a magnetic disk, or an optical disc.

The foregoing descriptions are merely specific implementations of the present disclosure, but are not intended to limit the protection scope of the present disclosure. Any equivalent variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What may be claimed is:

1. A four-wheel chassis comprising:
a body; and
a front wheel assembly and a rear wheel assembly detachably coupled to the body,
wherein one of the front wheel assembly and the rear wheel assembly is configured to independently move as a two-wheel chassis after being detached from the body, and
the one of the front wheel assembly and the rear wheel assembly is connected to a wheel driving controller that controls wheels of the two-wheel chassis.

2. The four-wheel chassis of claim 1, wherein:
the one of the front wheel assembly and the rear wheel assembly includes a connector for coupling a main device.

3. The four-wheel chassis of claim 2, wherein:
the main device includes at least one of a gimbal, a photographing device, a magazine, a firing device, or a detecting device.

4. The four-wheel chassis of claim 1, wherein:
the one of the front wheel assembly and the rear wheel assembly is coupled to the body by a suspension.

5. The four-wheel chassis of claim 4, wherein the one of the front wheel assembly and the rear wheel assembly includes:
a connecting plate coupled to the body by the suspension; and
a wheel coupled to the connecting plate by a screw.

6. The four-wheel chassis of claim 1, wherein:
the wheel driving controller is a four-wheel driving controller disposed at the body,
wherein the four-wheel driving controller is configured to control wheels of the front wheel assembly and the rear wheel assembly.

7. The four-wheel chassis of claim 6, wherein:
each of the front wheel assembly and the rear wheel assembly includes two motors, and
the four-wheel driving controller is configured to control the motors to drive the wheels.

8. The four-wheel chassis of claim 7, further comprising:
four electronic governors disposed at the body,
wherein:
input terminals of the four electronic governors are coupled to the four-wheel driving controller,
output terminals of the four electronic governors are respectively coupled to the four motors of the front wheel assembly and the rear wheel assembly, and
the four-wheel driving controller is configured to control the four motors to drive the wheels of the front wheel assembly and the rear wheel assembly through the four electronic governors.

9. The four-wheel chassis of claim 6, wherein:
the four-wheel driving controller is detachably coupled to the body,
the one of the front wheel assembly and the rear wheel assembly includes a controller interface for connecting to the four-wheel driving controller, and
the four-wheel driving controller is further configured to, after the one of the front wheel assembly and the rear wheel assembly is detached from the body and the four-wheel driving controller is connected to the controller interface, control the two wheels of the one of the front wheel assembly and the rear wheel assembly.

10. The four-wheel chassis of claim 1, wherein the wheel driving controller is a two-wheel driving controller configured to, after the one of the front wheel assembly and the rear wheel assembly is detached from the body, control wheels of the one of the front wheel assembly and the rear wheel assembly.

11. The four-wheel chassis of claim 10, wherein the two-wheel driving controller is configured to:
acquire a center of gravity of the one of the front wheel assembly and the rear wheel assembly, and
control the wheels of the one of the front wheel assembly and the rear wheel assembly according to the center of gravity.

12. The four-wheel chassis of claim 10, wherein:
the one of the front wheel assembly and the rear wheel assembly includes a connector for connecting a magazine and a bullet launcher; and
the two-wheel drive controller is configured to control the one of the front wheel assembly and the rear wheel assembly to fall down, or control an indicator to turn off, or generate smoke, after the one of the front wheel assembly and the rear wheel assembly is hit.

13. The four-wheel chassis of claim 1, wherein:
the one of the front wheel assembly and the rear wheel assembly includes a controller interface configured to connect the wheel driving controller, and
the wheel driving controller is a two-wheel driving controller that controls wheels after the one of the front wheel assembly and the rear wheel assembly is detached from the body.

14. A two-wheel chassis comprising:
wheels; and
a connecting plate coupled to the wheels,
wherein:
the connecting plate is configured to be detachably coupled to a body, and
the two-wheel chassis is configured to, after coupled to the body, form a four-wheel chassis with the body to move as a whole.

15. The two-wheel chassis of claim 14, further comprising:
a controller configured to control the wheels.

16. The two-wheel chassis of claim 15, wherein:
the controller is configured to acquire a center of gravity of the two-wheel chassis, and control the wheels according to the center of gravity.

17. The two-wheel chassis of claim 14, further comprising:
a controller interface for connecting the controller.

18. The two-wheel chassis of claim 14, further comprising:
a connector for connecting a main device.

19. A four-wheel chassis assembly comprising:
a main device; and
a four-wheel chassis comprising:
a body, and
a front wheel assembly and a rear wheel assembly detachably coupled to the body,
wherein after detached from the body, one of the front wheel assembly and the rear wheel assembly independently moves as a two-wheel chassis, and
the one of the front wheel assembly and the rear wheel assembly is connected to a wheel driving controller that controls wheels of the two-wheel chassis.
